(19) United States
(12) Patent Application Publication
(10) Pub. No.: US 2011/0038691 A1
(43) Pub. Date: Feb. 17, 2011

(54) DEVICE FOR THE SAFE TRANSFER OF PERSONNEL OR MATERIAL FROM AN OBJECT CONFIGURED AS A BOAT TO AN OBJECT MOVING RELATIVE THERETO, AND BOAT COMPRISING THE DEVICE

(76) Inventor: Stefan Leske, Rheinberg (DE)

Correspondence Address: KF ROSS PC, 5683 RIVERDALE AVENUE, SUITE 203 BOX 900, BRONX, NY, 10471-0900, US

(21) Appl. No.: 12/988,319

(22) PCT Filed: Apr. 27, 2009
(86) PCT No.: PCT/EP09/03049

§ 371 Date: Oct. 27, 2010

(30) Foreign Application Priority Data
Apr. 28, 2008 (DE) 10 2008 021 216.4
Apr. 3, 2009 (DE) 10 2009 016 082.5

(51) Int. Cl. B63B 27/10; B66F 11/04

(52) U.S. Cl. 414/139.5; 414/139.6

(57) ABSTRACT

The invention relates to a device for the safe transfer of personnel or material from an object configured as a boat to an object moving relative thereto. The device comprises a dedicated loading or unloading device, a transfer element, and a regulating device for minimizing the relative movement of the transfer element relative to the other object. The loading or unloading device is configured as an industrial robot (4, 14, 34), and the robot arm thereof is configured as a support arm. For this purpose, the transfer element is attached to the free end of the support arm, or is configured such that it may be connected to the free end of the support arm.

The invention relates to an apparatus for safely transferring personnel or material from a watercraft to another object moving relative thereto, having a loading and unloading device that is attached to the watercraft and that has a transfer element, for example a platform or a ladder/footbridge, and a control system for minimizing movement of the transfer element relative to the other object.

Such an apparatus is known from WO 2007/120039 [US 2010/0032543] (Technische Universität Delft).

Accessibility is one of the most important parameters for the cost-effectiveness of offshore facilities, for example wind-power stations. As a rule, accessibility is expressed as an index (in %) between theoretical and actual access. The actual possible access is essentially a function of two factors. One factor is the prevailing height of the waves, and the other is the ability of the access system to compensate for the wave movements to the greatest extent possible.

The currently prevailing idea is a landing maneuver in which the watercraft pulls in directly alongside the wind-power station. The watercraft is guided primarily by equipment and its degree of freedom is thus limited. Access to the wind-power station (WPS) is done directly from the watercraft (or its boom) to the ladder or a platform on the WPS at a favorable moment. The favorable moment is the moment at which relative movement between the watercraft and the WPS is as small as possible.

The fundamental flaws of this idea are clearly discernable. The favorable moment for the transfer remains a subjective criterion that is a function of the decisiveness and experience of the person who wants access to the WPS. It can have serious consequences for people.

Another essential disadvantage is that the accessibility of the WPS is limited by the prevailing height of the waves at the site. For the landing maneuver in the framework of the “watercraft landing” without excluding the swells, significant wave heights of about 1.5 meters constitute the limit, but this limit is exceeded very frequently, especially in the North Sea. Accessibility to wind-power stations using these conventional access methods is only about 55%. Simply having safe access during significant 3 meter wave heights would increase accessibility to 88%.

Apparatus for attaining this goal are already known (WO 2007/120039 A1; DE 699 17 050 [U.S. Pat. No. 6,827,032]; DE 199 46 899 A1; U.S. Pat. No. 4,011,615, DE 101 53 359 A1; U.S. Pat. No. 4,590,634), but are essentially distinguished from the invention described below in that they:
a) are not mounted on the mobile object, but rather are mounted on the fixed object (www.pts-offshore.com), or
b) do not compensate for the relative movements of the objects (for example www.sashsystem.com), or
c) compensate for the relative movements of the two objects with other techniques (www.ampelmann.n1) and WO 2007/120039).

Essential differences between the above-described Ampelmann system and the described invention are:
Compensation movements are generated by a hydraulic and pneumatic device based on a Stewart platform (hexapod);
Significant wave heights of more than 2 m can only be compensated for when mounted on large and heavy ships;
The Ampelmann system cannot be mounted on smaller watercraft in an effective size because of the space required and because of the weight;
The Ampelmann system is significantly more complex and expensive because of the technology used.
Due to its size, it is not possible to store the Ampelmann system in a housing protected from seawater or in the hull of the ship when it is not in use.

A mooring apparatus is known from the above-described DE 699 17 050 T2 a gangway for connecting a ship to an object constituting a structure. The gangway on the bow of the ship is rotatably mounted at one end and at the other end is provided with a control device. While the ship is laying to, the control device can be moved along the surface of the structure, and with it the end of the gangway, using the ship's movement. This mobility of the end of the gangway makes it possible for a retention device on the gangway to automatically couple to a fastening device for the structure. This automatic coupling mechanism is limited to certain wave heights. Ships of at least medium size are needed for transporting a gangway.

In addition, systems are known in which a crane mounted on a watercraft is used.

For instance, US H2163 H describes a shipboard crane that can pick a floating object from the water in high seas. To this end, the shipboard crane has a docking unit on its free end that is moved via a corresponding unit of the floating object using air or water jets controlled by optical sensors. Horizontal relative is movements of the floating object are compensated for by this arrangement, but vertical relative movements are not.

An apparatus is known from U.S. Pat. No. 4,327,784 for refueling an aircraft from a ship at sea. The apparatus has a first beam that is pivoted on the ship and a second beam that is pivoted to the first beam. An outlet for fuel is provided at the end of the second beam. The positions of the beams are controlled such that the fuel outlet remains in a constant position when the ship changes its position.

U.S. Pat. No. 6,505,574 describes another shipboard crane. It is provided with a hoist that raises or lowers the load suspended from the crane at the same speed as the speed in the opposite direction caused by the motion of the seas.

The underlying object of the invention is to enable safe transfer of personnel or material, not just in large and heavy ships, as in the system according to WO 2007/120039 A1, but also when mounted on substantially smaller watercraft, and to attain a significantly more compact structure for the apparatus so that when it is not in use the entire apparatus can be stored in a housing protected from seawater or in the hull. Finally, the inventive apparatus should also be much less complex and therefore should involve significantly lower costs.

This object is attained according to the invention with the apparatus of the above-described type in that the loading and unloading device is embodied as an industrial robot and its robot arm is embodied as support arm. The transfer element is attached to the free end of the support arm. Alternatively, the transfer element can be connected to the free end of the support arm.

The dependent claims recite advantageous embodiments of the invention.

The inventive apparatus is used for safely transferring personnel or material from a watercraft to another object moving relative thereto, for example an offshore wind-power station, other offshore object, or other watercraft, and back.

The transfer element is for example a platform or ladder/footbridge. A loading and unloading device that is embodied as an industrial robot with a robot arm as the support arm for the transfer element is a relatively small device that can be used on smaller watercraft. An industrial robot with a robot arm is also called an articulated-arm robot whose robot arm has a plurality of arm elements connected in series to one another by articulated joints. Such an industrial robot has five or six rotational axes. One example of such an industrial robot is a six-armed industrial robot with articulation kinematics from the Kuka Company's KR500 series.

The invention has especially significant advantages over comparable systems in that:
there can be no environmental load from escaping oil,
the apparatus has very compact construction,
is lighter,
is less expensive,
does not require any ancillary units such as a compressor or hydraulic unit.

This is attained inter alia in that the apparatus is electrically regulated and driven.

Another significant advantage over a Stewart platform known from WO 2007/120039 A1 is that a serial kinematic unit, specifically an articulated-arm robot, is used instead of the parallel kinematics of the hexapod. This enables compensation movement in a small space and thus enables use on smaller watercraft.

The support arm can preferably be moved with at least six degrees of freedom. To this end, for the loading and unloading device the inventive apparatus has for example a six-axis industrial robot whose six axes provide six degrees of freedom.

The robot arm embodied as a support arm is preferably movable by servomotors. The control system for minimizing the relative movement of the transfer element connected to the robot arm controls the servomotors moving the robot arm.

One apparatus according to the invention is preferably provided with a safety control unit that can be used to move the support arm to a safety position. When one or a plurality of robot axes are blocked, the safety control unit moves the support arm into the safety position via the remaining axes.

In one embodiment, an inventive apparatus has an adjusting apparatus on which the industrial robot is mounted on the watercraft such that it can be adjusted vertically, horizontally, and lengthwise. Using the adjusting apparatus the support arm can be moved in additional degrees of freedom in addition to the degrees of freedom possible due to the mobility of the robot arm.

A possible working area, also called working space, for the support arm is enlarged by these up to three movement axes.

In one embodiment, an inventive apparatus has an additional or alternative adjusting apparatus that includes a resetting unit on which the industrial robot itself is carried on the watercraft movable between a safety position and a working position. The resetting unit has for instance rails and a slide guided therein for the industrial robot. An industrial robot arranged on the stern or bow of the watercraft is movable for instance along an axis, specifically longitudinally, such that it can be displaced into the interior of the watercraft.

In the safety position a working area for the industrial robot is arranged such that a collision with objects outside of the geometry of the watercraft is precluded. The working area for the industrial robot is determined by its positioning on the deck of the watercraft and by mechanical and where necessary electronic limitation of the robot axes.

In the working position, the working area for the industrial robot is arranged using its changed positioning on the deck of the watercraft such that the industrial robot can use its robot arm to act outside of the geometry of the watercraft, as well.

The adjusting unit preferably has a tensioning unit that can move the industrial robot against a prestress, especially an increasing prestress, into the working position and that can release the industrial robot to move automatically into the safety position. Using the tensioning unit, and with the supply of energy, preferably supply of electric, pneumatic, or hydraulic energy, the industrial robot is moved out of the safety position into the working position for producing the prestress, for example by tensioning springs. The supplied energy is stored in the tensioning elements, for example in the springs.

One tensioning unit preferably has retaining elements for retaining the industrial robot, and when energized they also retain the industrial robot in the working position. The retaining elements are for example electrical, pneumatic, or hydraulic clamping cylinders. The retaining elements open automatically if there is a loss of power and open in a controlled manner if there is another emergency and release the industrial robot, which then automatically moves to the safety position due to the release of the energy stored in the tensioning elements. It is not necessary to supply energy to move the unit to the safety position. The tensioning unit makes it possible, for example if there is a loss of power, for the industrial robot to move to the safety position automatically. This ensures that it is not possible for there to be collisions with outboard objects if there is a loss of power.

In this embodiment, the inventive apparatus preferably has an adjustment control unit with which the adjusting unit can be controlled and which controls the adjustment of the industrial robot and which can be used to release the industrial robot, for example if there is a loss of power. In particular the tensioning unit can be controlled with the adjusting unit.

In one embodiment, the inventive apparatus has a protective apparatus for the industrial robot and any transfer element for the period of nonuse. This protective apparatus in particular protects against the effects of saltwater.

In one alternative of the invention, the transfer element is at least one platform and is attached to the free need of the support arm. A platform is preferably provided with safety elements, for example a personnel basket or cage, for safely transferring people. Preferably closed, i.e. opaque, side walls are provided. Preferably a transfer unit is provided or mounted on top of the platform or cage for the safe transfer of material. For safe transfer of material, an alternative or additional platform is preferably embodied as a load transfer unit on which the material can be provided with compensation for movement, for example for a shipboard crane of a wind power station. For instance, two different platforms may be alternately attached to the support arm.

In another alternative, the transfer element is embodied as a footbridge, for example a gangway, the transfer element being embodied such that it can be connected to the free end of the support arm.

The invention also relates to a watercraft having an inventive apparatus. The watercraft is preferably embodied relative small, preferably with a length of approximately 25 to 30 m and preferably with a displacement of approximately 25 to 30 t. A watercraft according to the invention significantly increases accessibility at sea to for example wind-power stations.

Embodiments of the invention are explained in greater detail using drawings in the following.

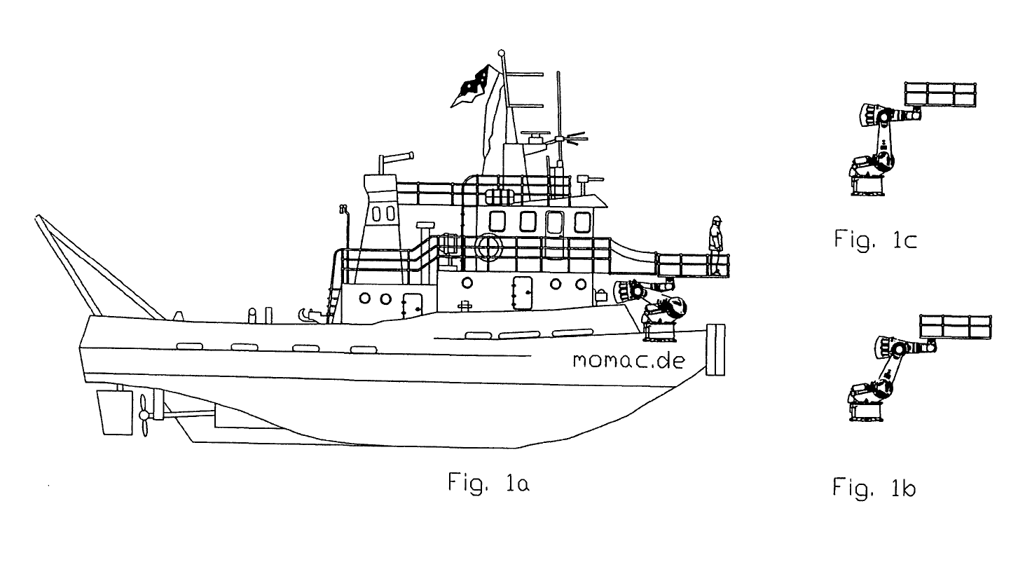

FIG. 1a is an overall view of a watercraft having the inventive arrangement in a first embodiment;

FIG. 1b is a detail of FIG. 1a, specifically the inventive apparatus with the platform in a retracted position;

FIG. 1c is a view like FIG. 1b, but with the platform in a partially extended position;

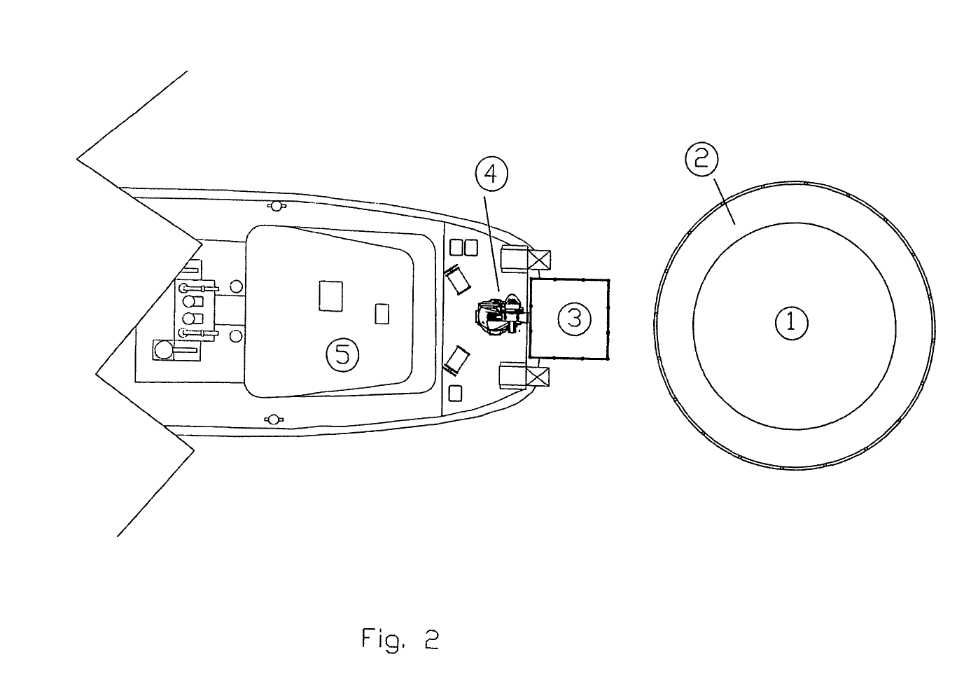

FIG. 2 is a top view of the watercraft having the inventive apparatus as in FIG. 1a as the watercraft approaches a wind-power station;

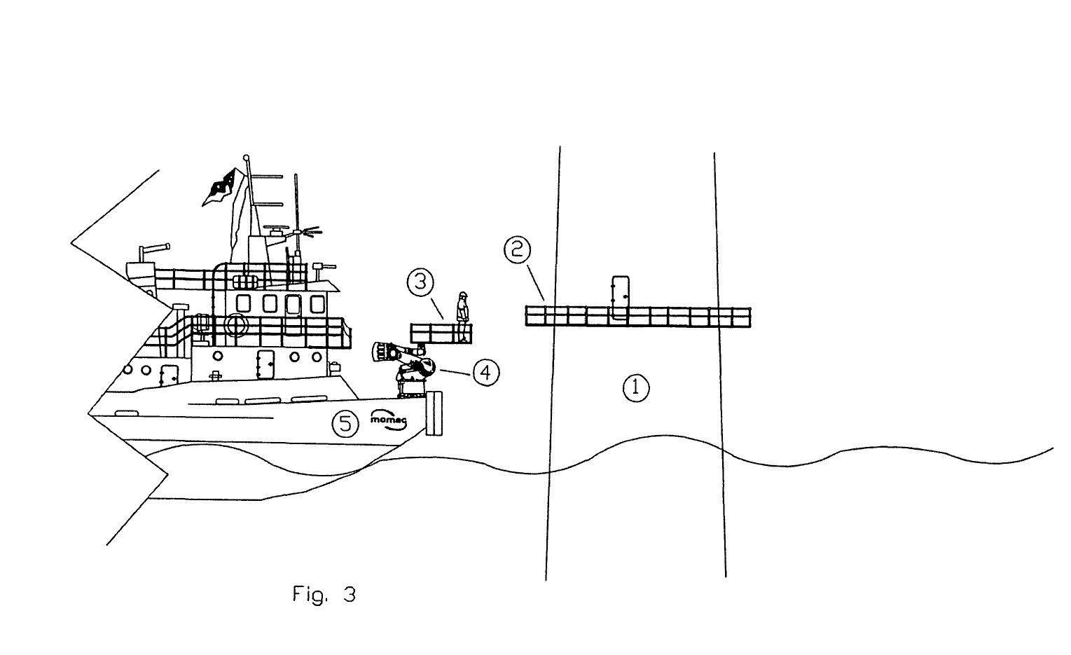

FIG. 3 is a side view of the arrangement as in FIG. 2 in a first position;

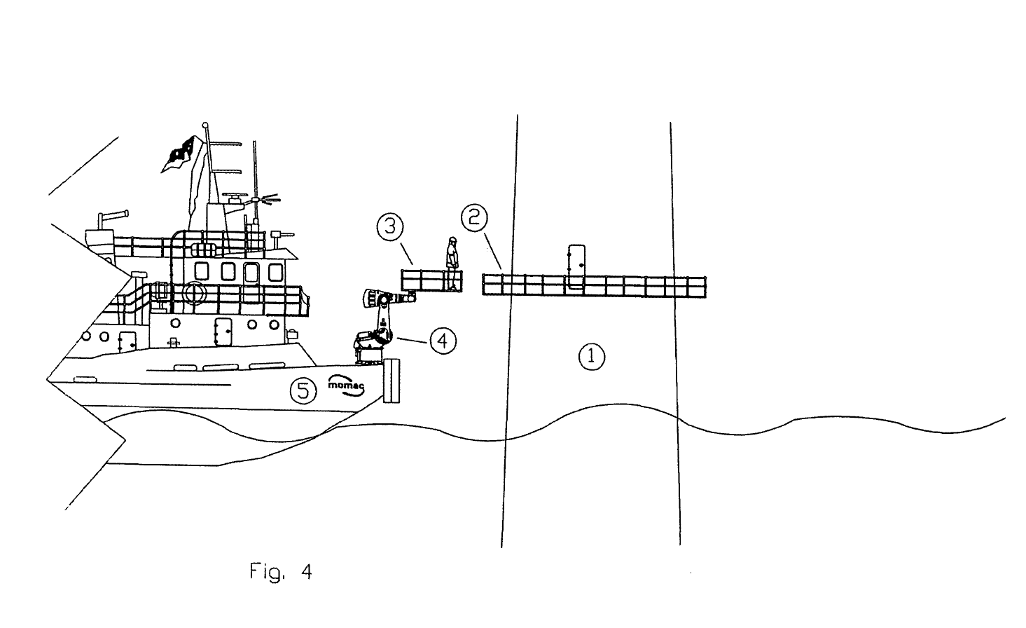

FIG. 4 is a view like FIG. 3, but at a later time, in which the platform is disposed in an intermediate position (Position 2);

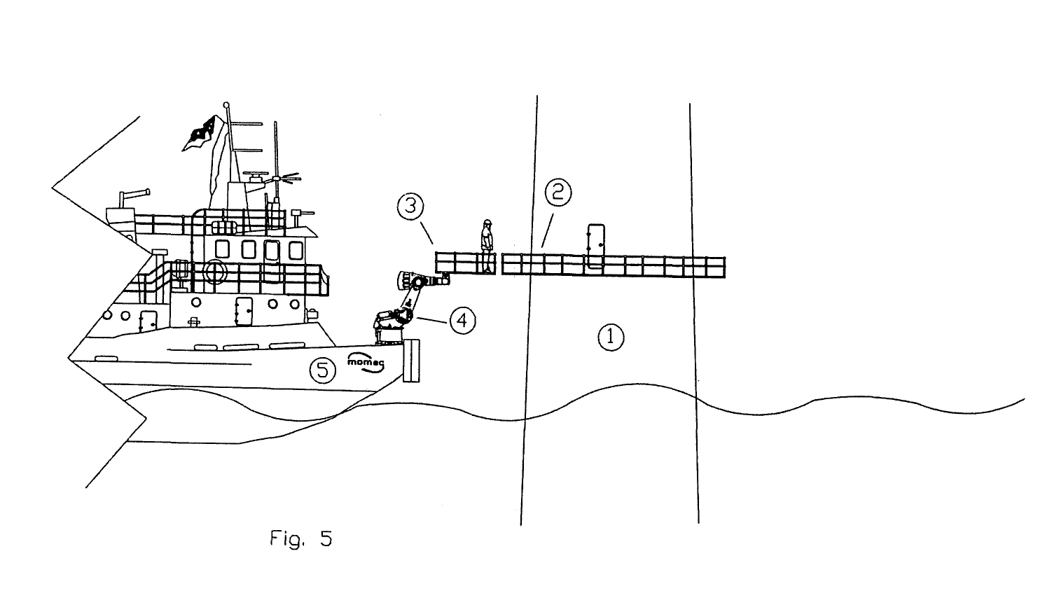

FIG. 5 is a view like FIG. 3 at an even later time, in which the platform is the position shown in order to transfer personnel and material to and from the wind-power station;

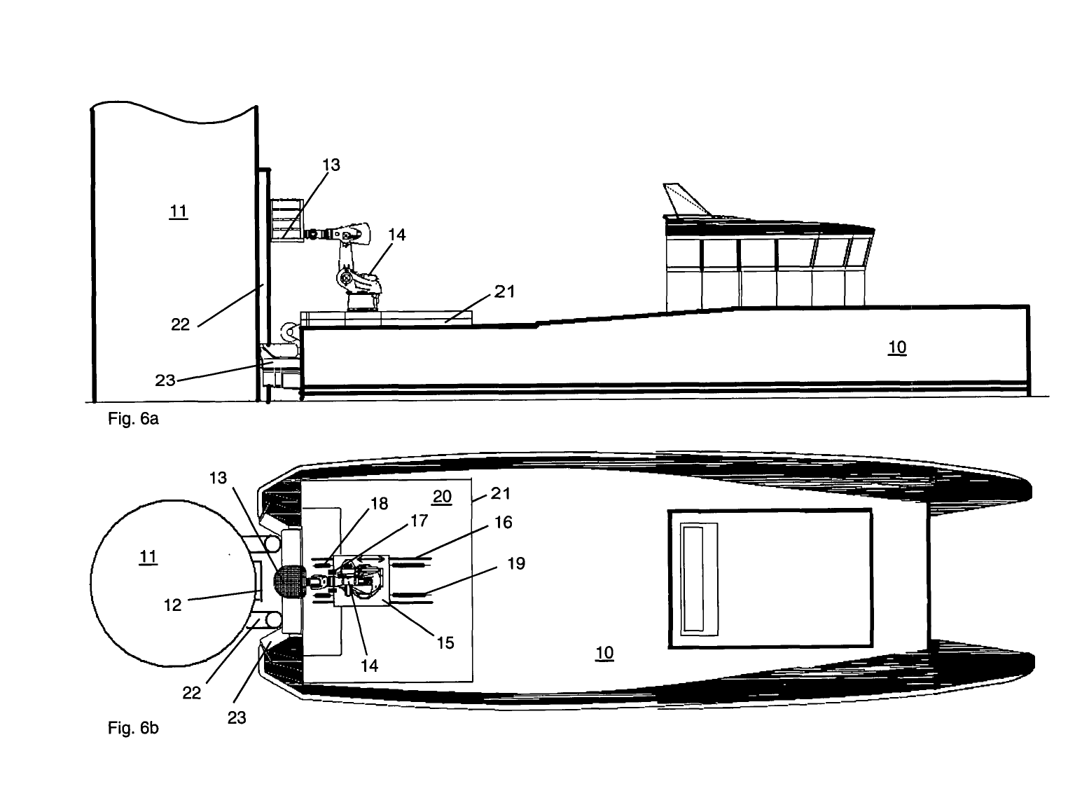

FIG. 6a is a schematic view of a second inventive embodiment, specifically a side view of a watercraft having an industrial robot at a wind-power station;

FIG. 6b is a top view of the watercraft at the wind-power station as in FIG. 6a;

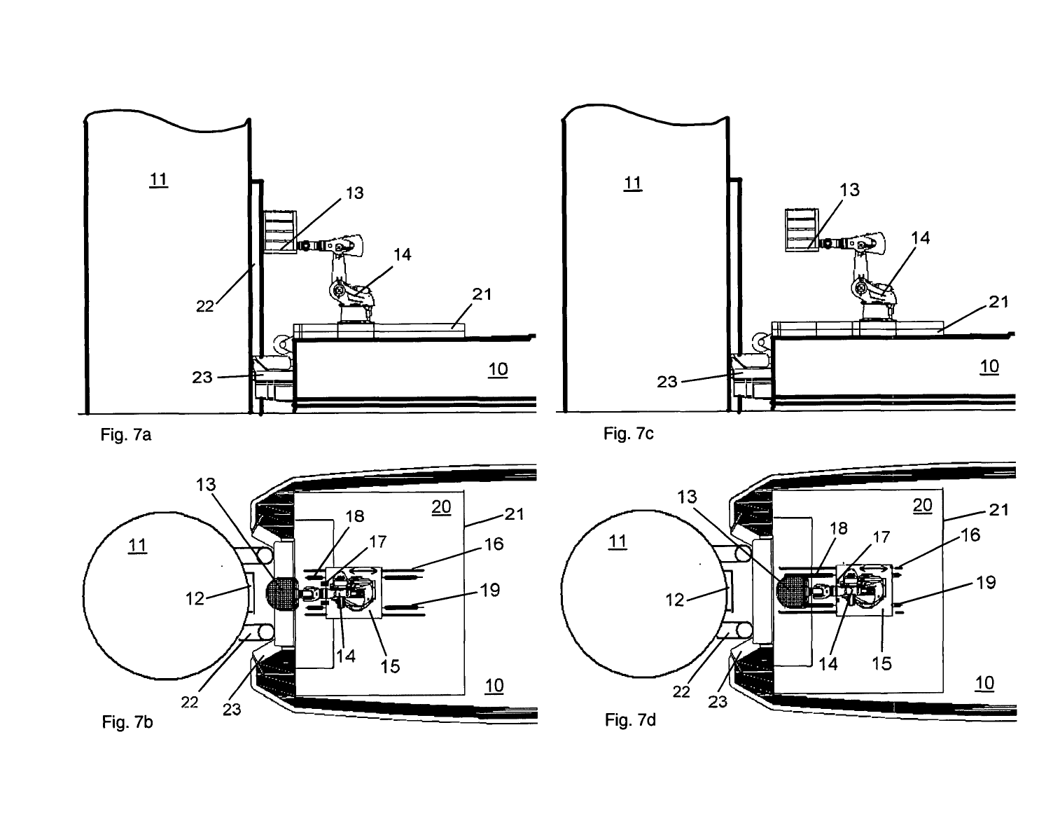

FIG. 7a is a front detail of the side view in FIG. 6a, the industrial robot in a working position;

FIG. 7b is a front detail of the top view of the watercraft shown in FIG. 7a at the wind-power station;

FIG. 7c is a front detail of the side view of FIG. 7a, the industrial robot being in a safety position;

FIG. 7d is a front detail of a top view of the watercraft shown in FIG. 7c at the wind-power station;

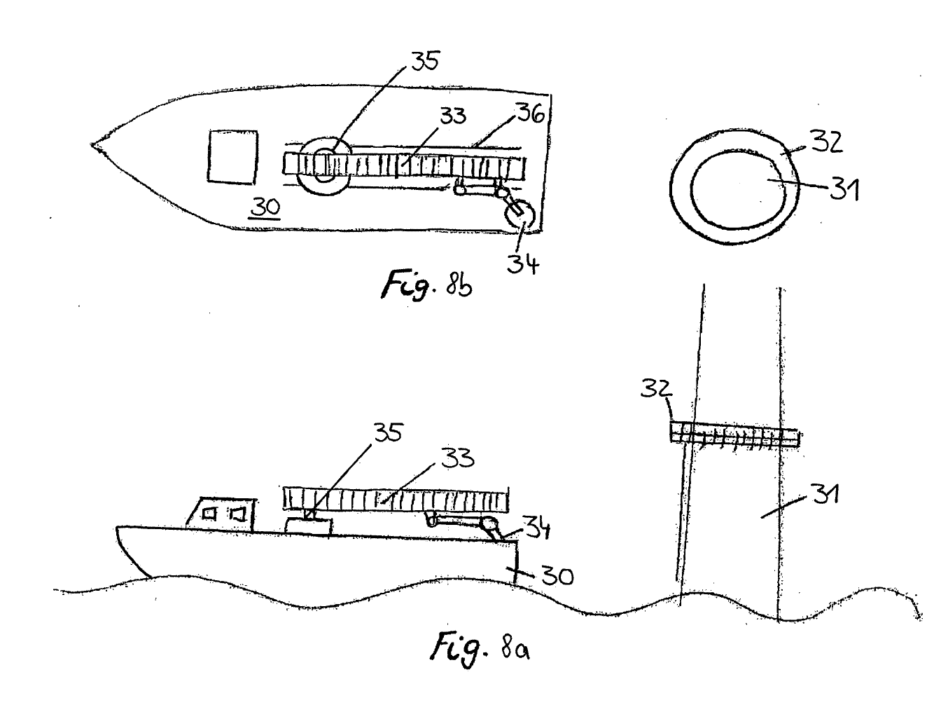

FIG. 8a is a schematic view of a third inventive embodiment, specifically a watercraft having an industrial robot and a transfer element embodied as a gangway;

FIG. 8b is a top view of the view of FIG. 8a;

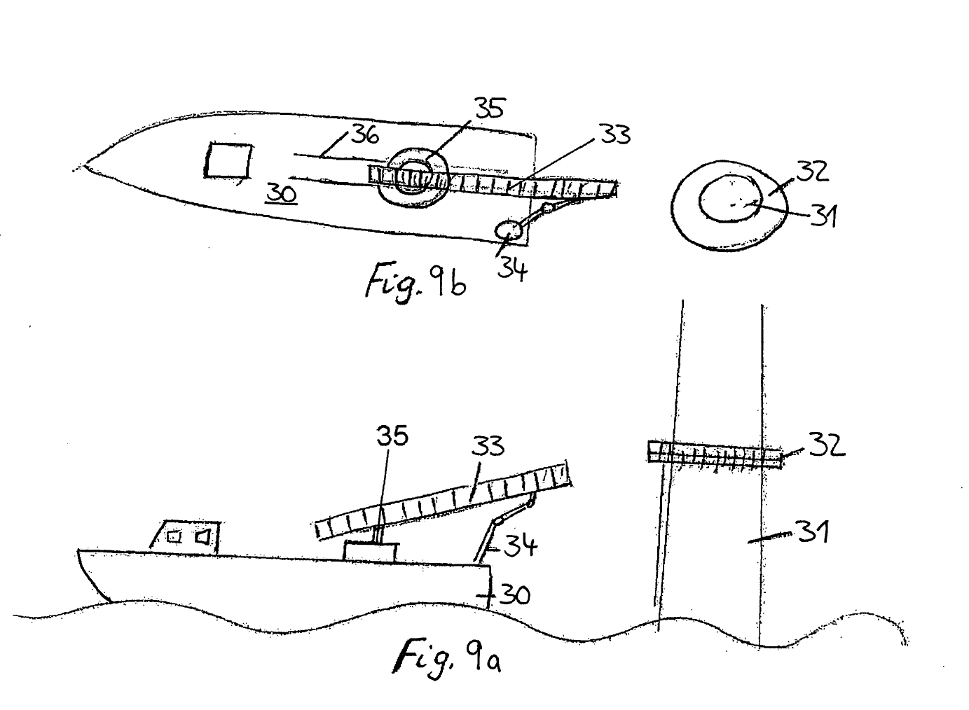

FIG. 9a is a side view corresponding to FIG. 8a, the gangway being extended;

FIG. 9b is a top view of the watercraft as shown in FIG. 9a;

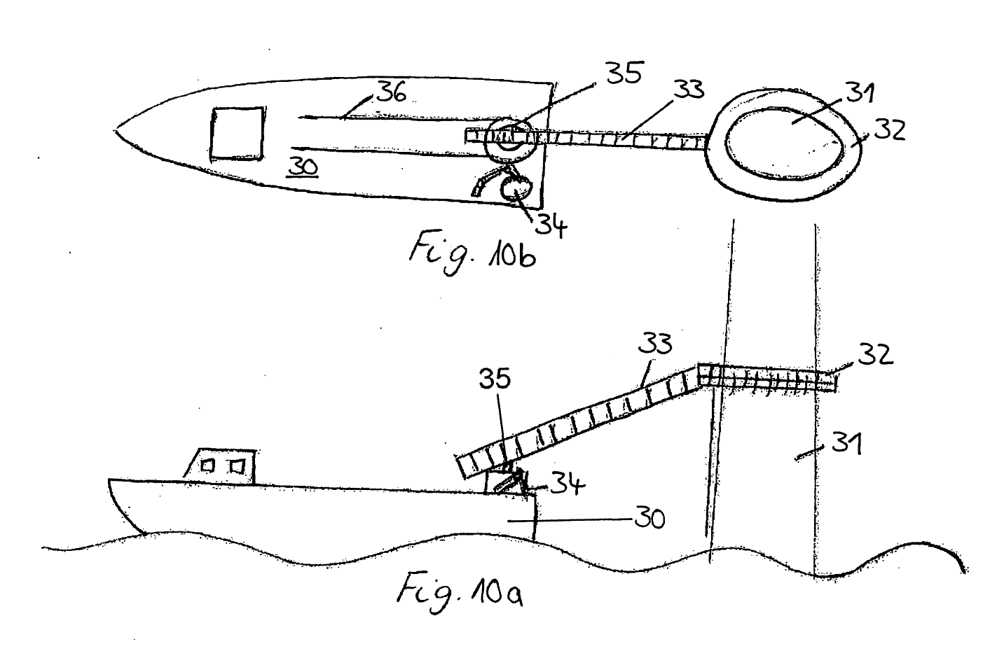

FIG. 10a is a side view corresponding to FIG. 8a, the gangway being coupled; and

FIG. 10b is a top view of the watercraft shown in FIG. 10a.

The same reference numbers have the same meaning in all of the figures and are therefore described only once.

### EXAMPLE 1

The drawings show a watercraft 5 having an inventive loading and unloading apparatus 4 that in a specific embodiment may be an industrial robot known per se. Attached to the end of this apparatus 4 is a platform 3 that can be used for bringing people and material to a circumferential “balcony” 2 of a wind-power station. This balcony is attached to the a tower 1 of the wind-power station.

The inventive apparatus safely transfers personnel or material from a moving object onto a fixed or also moving object.

The inventive apparatus is suitable mounting on a moving object (for example watercraft) and for independently compensating the movement of the watercraft relative to
a fixed standing object (for example offshore wind-power station/drilling platform) or
a moving object (for example another watercraft).

With this apparatus it is possible for personnel or a load, for example, to be safely transferred to other objects (fixed or moving), even in heavy seas.

The apparatus described in the embodiment comprises:
a support arm (robot arm) that can be moved along up to 6 axes simultaneously by means of servomotors;
a seventh and eighth and ninth axis in the form of an apparatus for making vertical, horizontal, and longitudinal adjustments for the entire support arm in order to compensate for especially large wave movements and changes in the position of the watercraft. The seventh, eighth, and/or ninth axis may also be hydraulic;
a platform attached to the “free end” of the robot, the platform being suitable for safely picking up people or loads and compensating for swells;
an electric control system for fixing the position of the platform relative to another object (minimizing relative movement) and preventing undesired collisions with other objects, specifically
   absolutely relative to the movement (compensation against a stationary object/surroundings), i.e. the sensors in the platform register absolute movement or,
   relative to an object that is also moving so that movement relative to this moving object is also compensated for;
a device that protects against the effects of saltwater on the apparatus for the period it is not in use.

The watercraft 5 is equipped with an autopositioning system (APS) that holds the watercraft 5 in position by engine power, even in heavy seas. In this embodiment the watercraft 5 does not touch the tower 1 during the transfer process.

### EXAMPLE 2

An inventive apparatus for the second example corresponds to that of the first example except for the following additional or alternative features.

An inventive apparatus for safely transferring personnel or material from a watercraft 10 to another object moving relative thereto, specifically for example to a wind-power station with a tower 11, via a ladder 12 attached to the tower, is provided on the inventive watercraft 10. The watercraft 10 is a catamaran, and the inventive apparatus is on its stern. The inventive apparatus has a transfer element embodied as a platform 13, a loading and unloading device embodied as an industrial robot 14, and a control system for minimizing relative movement of the transfer element, i.e. the platform 13, relative to the tower 11 of the wind-power station. One robot arm of the industrial robot 14 is a support arm having a free end carrying the platform 13. The industrial robot 14 is a six-axis articulated-arm robot so that the support arm can be moved about six axes and thus has six degrees of freedom. The support arm can be moved by servomotors. The control system is connected to the servomotors and controls them. The control system is connected to a sensor unit that records the movements of the watercraft 10 and forwards appropriate signals to the control system.

The apparatus is provided with a safety control unit for securing for example personnel, and it can move the support arm into a safety position, for example in an emergency. An emergency can be for example a known hazardous situation, for example blocking of one or a plurality of robot axes.

The apparatus has an adjusting apparatus with a resetting unit on which the industrial robot 14 is mounted on the watercraft 10 adjustable between a working position and a safety position. The resetting unit includes a slide 15 on which the industrial robot 14 is mounted and rails 16 on which the slide 15 is guided. In this embodiment, in which the industrial robot 14 is carried on the stern of the watercraft 10, the rails 16 are parallel to the longitudinal axis on the stern.

The resetting unit also includes a tensioning unit that can be used to move the industrial robot 14 into the working position against a prestress and that can be used to release the industrial robot 14, for example in an emergency, so that it automatically moves into the safety position. The tensioning unit has tensioning elements, for example tension springs or hydraulic cylinders, that run parallel to the rails 16 and has retaining elements 17. The tensioning elements are pressure elements 18 and traction elements 19 and are connected to the slide 15 carrying the industrial robot 14. The retaining elements 17, of which only their position on the slide 15 is shown in the drawing, hold the slide 15 in the working position on the rails under the prestress of the tensioning elements. The prestress is built up by the slide 15 moving with the industrial robot 14 out of the working position into the safety position. The pressure elements 18 between stern and slide 15 exert pressure on the slide 15 and the traction elements 19 between the slide 15 and an inner position exert traction on the slide 15. When the retaining elements 17 are released, the slide 15 and thus the industrial robot 14 are automatically moved along the rails 16 into the safety position by the pressure elements 18 and the traction elements 19.

The apparatus has an adjusting unit with which the adjusting apparatus can be controlled. In particular the retaining elements 17 for the tensioning unit can be controlled such that for example when there is a power loss or another emergency they are released automatically and they release the slide 15 with the industrial robot 14.

The apparatus is furthermore provided with a protective device (not shown in the drawing) for the industrial robot 14 and for the transfer element embodied as a platform 13 for providing protection against seawater, which protective device is employed when the apparatus is not in use. The protective device has for example a cover for the industrial robot 14 with the platform 13.

The platform 13 is provided with safety elements for transferring personnel. The platform 13 especially has a cage that is shown in the drawing and that is open at a crossing side and at an opposing access side has a door with a grille that provides a view of a person and furthermore has closed and therefore opaque side walls and a roof. For the safety of people, also provided on the platform 13 are a saddle, cushioning on the side walls, head cushioning on the ceiling, safety belts, an intercom system, and a dead-man's switch.

A safety area 20 identified in FIG. 6b that has for example a protective fence 21 embodied as a lattice fence is defined on the watercraft 10 around the resetting unit with the industrial robot 14 arranged on the slide 15.

In one embodiment a transfer unit from which material, for example tools and/or other loads may be transferred to the wind-power station is provided on the platform 13, specifically on top of the roof of the cage. The tools and/or the loads on this transfer unit are provided by the industrial robot 14 in a movement-compensated manner for a wind-power station crane for example.

In order to assure a certain safety interval between the is tower 11 of the wind-power station and the watercraft 10, the tower 11 is provided with spacer bollards 22 and the watercraft 10 is provided with roller bumpers 23, the roller bumpers 23 acting as guides for the spacer bollards 22 as the watercraft 10 approaches the tower 11. This is illustrated in FIG. 6b.

For safely transferring personnel, the watercraft 10 with the roller bumpers 23 on its stern moves against the spacer bollards 22 and thus into a defined position at a specific distance from the ladder 12 for the tower 11 of the wind-power station.

Then a person walks onto the platform 13, which is in an entry position, and uses the safety elements to secure himself. Then the industrial robot 14 moves the person relative to the watercraft 10 so that its movement relative to the tower 11 is minimized. The person can then transfer to the ladder 12.

In an emergency, the robot arm is moved to a safety position and/or the entire industrial robot 14 is automatically moved into the safety position. In this safety position it is not possible for the platform 13 to collide with objects outside f the watercraft's footprint (outboard).

In an alternative embodiment, the platform 13 is embodied only as a load transfer unit for transferring materials, for example tools and/or loads. The industrial robot 14 provides the tools and/or other loads are provided on the load transfer unit in a movement-compensated manner for example for a wind-power station crane.

In another alternative, two platforms 13 are provided, one platform 13 being provided with a cage and one platform 13 being embodied as a load transfer unit and the platforms 13 being alternately attached to the free end of the support arm depending on use.

### EXAMPLE 3

An inventive apparatus for the third example corresponds to that of the second embodiment except for the following features.

An inventive apparatus according to the third example is also arranged on the stern of an inventive watercraft 30 that is employed for safely transferring personnel or material for example to a drilling platform. The drilling platform has a tower 31 and a circumferential balcony 32 attached to the tower 31.

The inventive apparatus has a transfer element embodied as a gangway 33 and a loading and unloading device embodied as an industrial robot 34. The gangway 33 is constructed such that its end that is to be coupled to the tower 31 may be connected to the free end of the support arm for the industrial robot 34. The end of the gangway 33 that is to be coupled has coupling elements that can be connected in a positive or nonpositive fit to corresponding coupling elements on the balcony 32 attached to the tower 31.

The gangway 33 at its opposite end is mounted on an attachment on the watercraft and freely rotatable, and that can especially be pivoted vertically and horizontally. In a rest position shown in one of the FIGS. 8a and 8b, the gangway 33 extends longitudinally on the watercraft 30. The attachment 35 is arranged with the gangway 33 on an adjusting device 36, for example with rails that run longitudinally on the watercraft 30.

The industrial robot 34 extends horizontally adjacent the gangway 33 on the stern of the watercraft 30.

In one alternative, the inventive apparatus is provided with an adjusting device (not shown) on which the industrial robot is mounted such that it is at least vertically adjustable. In addition or alternatively, the adjusting apparatus is also embodied for horizontal and longitudinal adjustability of the industrial robot 34.

In another alternative, the inventive apparatus has a protective apparatus only for the industrial robot 34 to protect it against seawater.

For safely transferring personnel or material, the watercraft 30 moves its stern toward the tower 31, its roller bumpers pressing against spacer bollards for the tower 31. The free end of the support arm for the industrial robot 34 is connected to the end of the gangway 33 that is to be coupled or to a center section of the gangway 33. The industrial robot 34 pulls the gangway 33 outward along the adjusting device 36 and guides the end of the gangway 33 that is to be coupled toward the balcony 32, where the gangway 33 is coupled to the balcony 32. After the coupling process, the industrial robot 34 releases the gangway 33 and moves back into a rest position until the decoupling process. A person may now cross over the freely moving gangway 33 to the balcony 32.

### REFERENCE LIST

1 Tower for the wind-power station
2 Circumferential balcony for the wind-power station
3 Platform (transfer element)
4 Loading/unloading device (industrial robot)
5 Watercraft
6 Watercraft
10 Tower for a wind-power station
12 Ladder
13 Platform (transfer element)
14 Industrial robot
15 Slide
16 Rails
17 Retaining elements
18 Pressure element
19 Traction element
20 Safety area
21 Protective fence
22 Spacer bollard
23 Roller bumper
30 Watercraft
31 Tower for a drilling platform
32 Balcony
33 Gangway (transfer element)
34 Industrial robot
35 Attachment
36 Adjusting device

1. An apparatus for safely transferring personnel or material from a watercraft to another object moving relative thereto, having a shipborne loading and unloading device, with a transfer element and a control system for minimizing movement of the transfer element relative to the other object, wherein the loading and unloading device is embodied as an industrial robot and its robot arm is a support arm, the transfer element being attached to the free end of the support arm or being embodied such that it can be connected to the free end of the support arm.

2. The apparatus in accordance with claim 1, wherein the support arm can be moved in at least six degrees of freedom.

3. The apparatus in accordance with claim 1 wherein the support arm can be moved by servomotors, the servomotors being controllable by the control system.

4. The apparatus in accordance with claim 1, further comprising
a safety control unit that can be used to move the support arm to a safety position.

5. The apparatus in accordance with claim 1, further comprising
an adjusting apparatus on which the industrial robot is mounted on the watercraft such that it can be adjusted vertically, horizontally, and lengthwise.

6. The apparatus in accordance with 1, further comprising
an adjusting apparatus having a resetting unit on which the industrial robot is carried on the watercraft movable between a safety position and a working position.

7. The apparatus in accordance with claim 6, wherein the resetting unit has a tensioning unit that can move the industrial robot against a prestress into the working position and that can automatically release the industrial robot to move into the safety position.

8. The apparatus in accordance with claim 6, further comprising
an adjustment control unit with which the adjusting apparatus can be controlled.

9. The apparatus in accordance with claim 1, further comprising
a protective apparatus for the industrial robot and any transfer element.

10. The apparatus in accordance with claim 1, wherein the transfer element is at least one platform and is attached to the free end of the support arm.

11. The apparatus in accordance with claim 1, wherein the transfer element is a gangway.

12. An arrangement with a watercraft and an apparatus in accordance with claim 1.
